(19) United States
(12) Patent Application Publication
(10) Pub. No.: US 2006/0132443 A1
(43) Pub. Date: Jun. 22, 2006

(54) Controlling a light source of an optical pointing device based on surface quality

(76) Inventor: Francis Ling Chien Wu, Fremont, CA (US)

Correspondence Address: AVAGO TECHNOLOGIES, LTD., P.O. BOX 1920, DENVER, CO, 80201-1920, US

(21) Appl. No.: 11/017,249

(22) Filed: Dec. 20, 2004

(51) Int. Cl. G09G 5/08

(52) U.S. Cl. 345/166

(57) ABSTRACT

A method for controlling a light source of an optical pointing device includes generating quality data representative of a surface quality of an imaging surface being imaged by the optical pointing device. The method includes controlling the light source based on the generated quality data.

### BACKGROUND

The use of a hand operated pointing device for use with a computer and its display has become almost universal. One form of the various types of pointing devices is the conventional (mechanical) mouse, used in conjunction with a cooperating mouse pad. Mechanical mice typically include a rubber-surfaced steel ball that rolls over the mouse pad as the mouse is moved. Interior to the mouse are rollers, or wheels, that contact the ball at its equator and convert its rotation into electrical signals representing orthogonal components of mouse motion. These electrical signals are coupled to a computer, where software responds to the signals to change by a ΔX and a ΔY the displayed position of a pointer (cursor) in accordance with movement of the mouse.

In addition to mechanical types of pointing devices, such as a conventional mechanical mouse, optical pointing devices have also been developed. In one form of an optical pointing device, rather than using a moving mechanical element like a ball, relative movement between an imaging surface, such as a finger or a desktop, and photo detectors within the optical pointing device, is optically sensed and converted into movement information.

Limiting the power consumed by optical pointing devices is important for portable electronic devices, such as portable computers, cellular telephones, personal digital assistants (PDA's), digital cameras, portable game devices, pagers, portable music players (e.g., MP3 players), and other similar devices that might incorporate an optical pointing device. Limiting power consumption is also important for wireless optical pointing devices, such as wireless optical mice.

One major source of power drain in optical pointing devices is the light source typically used in these devices. For an optical mouse, the light source, such as a light emitting diode (LED), illuminates the surface under the mouse. While the mouse is moved, the LED is typically turned on at a constant frequency based on the frame rate of the optical pointing device. Techniques have been developed to reduce the power drain caused by the light source. For example, some optical motion sensors for optical pointing devices include a low-power or “sleep” mode that is automatically entered if no motion is detected for a period of time. In low power mode, power savings is achieved by turning off the light source of the optical pointing device, or turning the light on less frequently than in full power mode.

It would be desirable to further reduce the power drain caused by the light source in an optical pointing device.

### SUMMARY

One form of the present invention provides a method for controlling a light source of an optical pointing device. The method includes generating quality data representative of a surface quality of an imaging surface being imaged by the optical pointing device. The method includes controlling the light source based on the generated quality data.

### BRIEF DESCRIPTION OF THE DRAWINGS

FIG. 1 is a top view of an optical pointing device according to one embodiment of the present invention.

FIG. 2 is a block diagram illustrating major components of the optical pointing device shown in FIG. 1 according to one embodiment of the present invention.

FIG. 3 is a flow diagram illustrating a method for generating movement data with the optical pointing device shown in FIGS. 1 and 2 according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

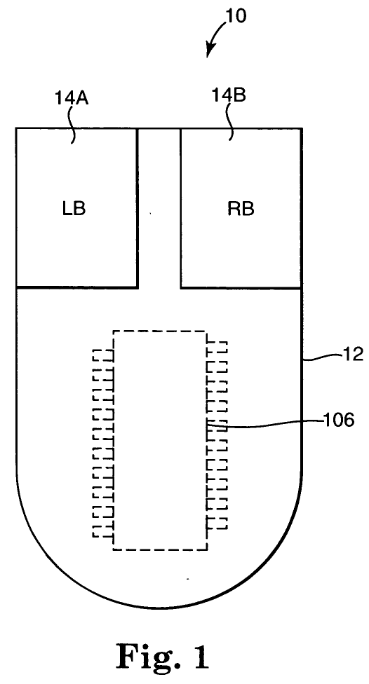

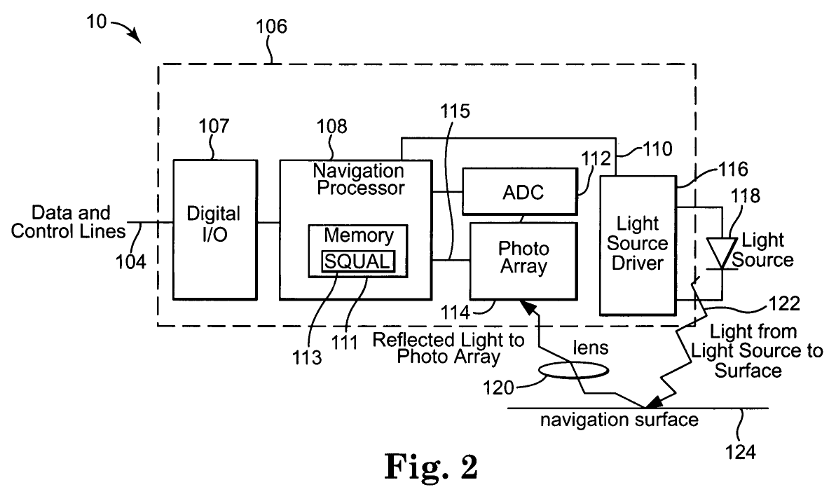

FIG. 1 is a top view of an optical pointing device 10 according to one embodiment of the present invention. In the illustrated embodiment, optical pointing device 10 is an optical mouse. Pointing device 10 includes plastic case 12, left button (LB) 14A, right button (RB) 14B, and optical navigation sensor integrated circuit (IC) 106 (also referred to as optical motion sensor 106). Optical motion sensor 106 is covered by plastic case 12, and is therefore shown with dashed lines in FIG. 1. Pointing device 10 according to one form of the invention is described in further detail below with reference to FIG. 2.

FIG. 2 is a block diagram illustrating major components of optical pointing device 10 according to one embodiment of the present invention. Optical pointing device 10 includes optical motion sensor 106, light source 118, and lens 120. Optical motion sensor 106 includes digital input/output circuitry 107, navigation processor 108, analog to digital converter (ADC) 112, photodetector array (photo array) 114, and light source driver circuit 116. Navigation processor 108 includes memory 111. In one embodiment, optical pointing device 10 is an optical mouse for a desktop personal computer, workstation, portable computer, or other device. In another embodiment, optical pointing device 10 is configured as an optical fingerprint sensing pointing device, or other pointing device.

In operation, according to one embodiment, light source 118 emits light 122 onto navigation surface 124, which is a desktop or other suitable imaging surface, and reflected images are generated. In one embodiment, light source 118 is a light emitting diode (LED). Light source 118 is controlled by driver circuit 116, which is controlled by navigation processor 108 via control line 110. In one embodiment, control line 110 is used by navigation processor 108 to cause driver circuit 116 to be powered on and off, and correspondingly cause light source 118 to be powered on and off.

Reflected light from surface 124 is directed by lens 120 onto photodetector array 114. Each photodetector in photodetector array 114 provides a signal that varies in magnitude based upon the intensity of light incident on the photodetector. The signals from photodetector array 114 are output to analog to digital converter 112, which converts the signals into digital values of a suitable resolution (e.g., eight bits). The digital values represent a digital image or digital representation of the portion of the desktop or other navigation surface or imaging surface under optical pointing device 10. The digital values generated by analog to digital converter 112 are output to navigation processor 108. The digital values received by navigation processor 108 are stored as frames within memory 111.

The overall size of photodetector array 114 is preferably large enough to receive an image having several features. Images of such spatial features produce translated patterns of pixel information as optical pointing device 10 moves over navigation surface 124. The number of photodetectors in array 114 and the frame rate at which their contents are captured and digitized cooperate to influence how fast optical pointing device 10 can be moved across a surface and still be tracked. Tracking is accomplished by navigation processor 108 by comparing a newly captured sample frame with a previously captured reference frame to ascertain the direction and amount of movement.

In one embodiment, navigation processor 108 performs a cross-correlation of sequential frames to determine motion information. In one form of the invention, the entire content of one of the frames is shifted by navigation processor 108 by a distance of one pixel successively in each of the eight directions allowed by a one pixel offset trial shift (one over, one over and one down, one down, one up, one up and one over, one over in the other direction, etc.). That adds up to eight trials. Also, since there might not have been any motion, a ninth trial “null shift” is also used. After each trial shift, those portions of the frames that overlap each other can then be multiplied and summed by navigation processor 108 to form a measure of similarity (correlation) within that region of overlap. In another embodiment, larger trial shifts (e.g., two over and one down) may be used. The trial shift with the greatest correlation can be taken as an indication of the motion between the two frames. That is, it provides raw movement information that may be scaled and or accumulated to provide movement information (ΔX and ΔY) of a convenient granularity and at a suitable rate of information exchange, which is output to a host device by digital input/output circuitry 107 on data and control lines 104. Optical pointing device 10 is also configured to receive data and control signals from a host device via data and control lines 104.

In one embodiment, photodetector array 114 includes an electronic shutter for controlling the charge accumulation time of the photodetectors. When the electronic shutter is “open,” charge is accumulated, creating voltages that are related to the intensity of light incident on the photodetectors in array 114. At the end of an integration time, the electronic shutter is “closed,” and no further charge accumulates. In one form of the invention, navigation processor 108 is configured to control the charge accumulation time of photodetector array 114 via control line 115, to help ensure proper exposure, and to help ensure that successive images have a similar exposure. In one embodiment, navigation processor 108 checks the values of the captured digital image data and determines whether there are too many minimum values or too many maximum values. If there are too many minimum values, navigation processor 108 increases the charge accumulation time of photodetector array 114 via control line 115. If there are too many maximum values, navigation processor 108 decreases the charge accumulation time of photodetector array 114. In one embodiment, navigation processor 108 averages all of the pixels in each captured digital image, and adjusts the charge accumulation time of array 114 based on the calculated average values.

In one form of the invention, an image is captured and processed by optical motion sensor 106 during a frame period. A frame period includes three phases—an integration phase, an analog to digital (A/D) conversion phase, and an image processing phase. During the integration phase, light is “collected” by photodetector array 114, and charge is accumulated. During the A/D conversion phase, the accumulated charge is converted into digital data by analog to digital converter 112. During the image processing phase, navigation processor 108 processes the digital image data and generates incremental ΔX, ΔY movement data, which is output to a host device. In one embodiment, during each frame period, navigation processor 108 causes light source 118 to turn on during the integration phase, and to turn off during the A/D conversion phase and the image processing phase.

In one embodiment, navigation processor 108 is configured to calculate surface quality (SQUAL) values 113, which are stored in memory 111. In one embodiment, navigation processor 108 examines each captured frame stored in memory 111, and identifies the number of surface features appearing in the frame. Navigation processor 108 stores a SQUAL value 113 for the current frame in memory 111. The stored SQUAL value 113 represents the identified number of surface features in the current frame. In one form of the invention, navigation processor 108 updates the SQUAL value 113 stored in memory 111 for each captured image frame. In one embodiment, each SQUAL value 113 is in the range of 0 to 255.

Surface features according to one embodiment are defined to include patterns appearing in a captured image that are caused by the microscopic texture or roughness of the navigation surface 124, such as bright and dark regions in a captured image caused by ridges and valleys, or other imperfections in the surface 124. If the optical pointing device 10 is lifted off of the navigation surface 124, such as a desk top, there will be little or no surface features appearing in the captured frames, and the SQUAL values 113 will approach zero. On an “easy-to-navigate” surface 124, and when the optical pointing device 10 is at an optimum distance from the surface 124, the SQUAL values 113 approach a maximum value. The higher the SQUAL value 113, the higher the quality of the surface 124 for the purpose of performing navigation computations.

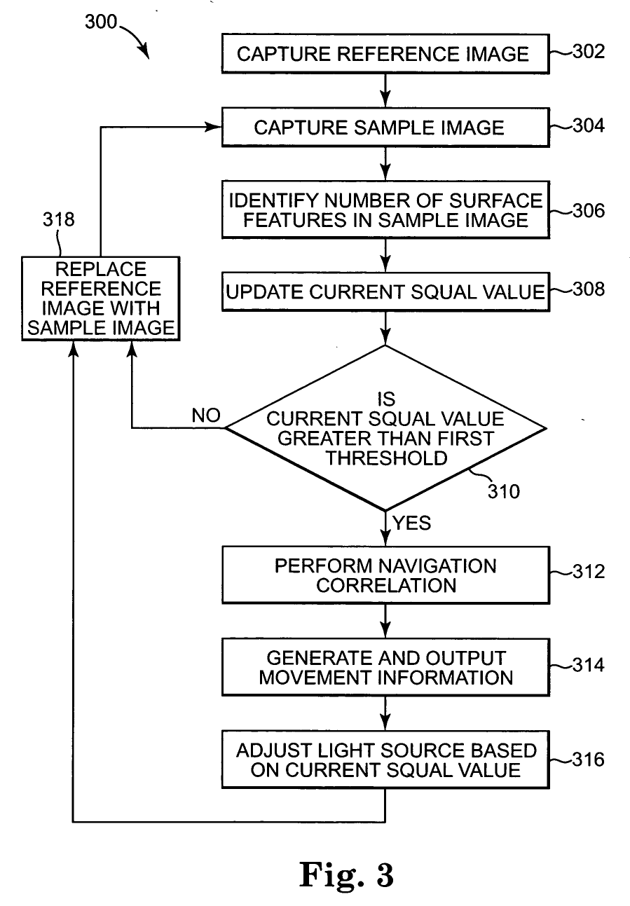

In one embodiment, navigation processor 108 performs a navigation process, including cross-correlation of successive image frames and calculation of movement data, only if the current SQUAL value 113 is above a minimum threshold value. In one form of the invention, if the current SQUAL value 113 falls below the minimum threshold value, navigation processor 108 outputs zero values for the movement data, and stops the navigation process until the current SQUAL value 113 rises back above the minimum threshold value. When the SQUAL value 113 rises back above the minimum threshold value, navigation processor 108 resumes the navigation process. In one embodiment, navigation processor 108 is also configured to control the light source 118 based on the current SQUAL value 113. The use of the SQUAL values 113 by navigation processor 108 according to one embodiment of the present invention is described in further detail below with reference to FIG. 3.

FIG. 3 is a flow diagram illustrating a method 300 for generating movement data with the optical pointing device 10 shown in FIGS. 1 and 2 according to one embodiment of the present invention. At 302, a reference image is acquired by photo array 114 (FIG. 2). The acquired image is converted into a digital image by analog to digital converter 112, and the reference digital image is output to navigation processor 108. At 304, a sample image is acquired by photo array 114. The acquired image is converted into a digital image by analog to digital converter 112, and the sample digital image is output to navigation processor 108.

At 306, navigation processor 108 identifies the number of surface features appearing in the sample digital image (acquired at 304). At 308, navigation processor 108 stores a SQUAL value 113 for the sample digital image in memory 111. The stored SQUAL value 113 represents the identified number of surface features appearing in the sample digital image.

At 310, navigation processor 108 determines whether the current SQUAL value 113 stored in memory 111 is greater than a first threshold value. The first threshold value, according to one embodiment, represents the minimum number of surface features needed by the optical motion sensor 106 to perform the navigation process. If it is determined at 310 that the current SQUAL value 113 is greater than the first threshold value, method 300 moves to 312. If it is determined at 310 that the current SQUAL value 113 is not greater than the first threshold value, method 300 moves to 318.

At 312, navigation processor 108 correlates the reference digital image (acquired at 302) with the sample digital image (acquired at 304), and determines a magnitude and direction of movement based on the correlation. At 314, navigation processor 108 generates movement information based on the correlation performed at 312, and outputs the movement information to a host device via digital input/output circuitry 107.

At 316, navigation processor 108 adjusts the light source 118 based on the current SQUAL value 113 (determined at 306). In one form of the invention, at 316, navigation processor 108 sends a control signal to light source driver 116 via control line 110, which causes light source driver 116 to change the drive signal provided to light source 118.

In one form of the invention, at 316, navigation processor 108 determines whether the current SQUAL value 113 is greater than a second threshold value. In one embodiment, the second threshold value is slightly less than the maximum possible SQUAL value. Thus, in this embodiment, if the current SQUAL value 113 is greater than the second threshold value, this indicates that the optical pointing device 10 is likely positioned on an “easy-to-navigate” surface 124. If it is determined that the current SQUAL value 113 is greater than the second threshold value, in one embodiment, the control signal sent by navigation processor 108 causes light source driver 116 to decrease the amount of light output by light source 118 from a normal amount to a reduced amount. When the optical pointing device 10 is positioned on an “easy-to-navigate” surface 124, the amount of light output by light source 118 can be reduced from the normal amount without adversely affecting the navigation computations. If navigation processor 108 later determines that the current SQUAL value 113 is no longer greater than the second threshold value, navigation processor 108 causes light source driver 116 to return the amount of light output by light source 118 to the normal amount.

In one embodiment, the control signal sent by navigation processor 108 at 316 to reduce the amount of light, causes light source driver 116 to reduce the drive current provided to light source 118, which reduces the amplitude or intensity of the light output by light source 118. In another embodiment, the control signal sent by navigation processor 108 at 316 to reduce the amount of light causes light source driver 116 to reduce the duty cycle (e.g., on time) of the drive signal provided to light source 118, which correspondingly reduces the duty cycle of the light signal output by light source 118. In one embodiment, a control signal sent by navigation processor 108 to increase the amount of light causes light source driver 116 to increase the drive current, thereby increasing the amplitude or intensity of the light output by light source 118, or increase the duty cycle of the signal provided to the light source 118, thereby increasing the duty cycle of the light signal output by light source 118.

In another embodiment of the present invention, rather than using a single threshold value to trigger adjustments to the light source 118 between a normal amount and a reduced amount, multiple thresholds and light amount amounts are used. In yet another embodiment, navigation processor 108 is configured to continually adjust the light source 118 based on the current SQUAL values 113. In one form of this embodiment, navigation processor 108 causes the amplitude and/or duty cycle of the light output by light source 118 to decrease as the SQUAL values 113 increase, and causes the amplitude and/or duty cycle of the light output by light source 118 to increase as the SQUAL values 113 decrease. After adjusting the light source at 316, method 300 moves to 318.

At 318, the reference digital image (acquired at 302) is replaced by the sample digital image (acquired at 304), which then becomes the reference digital image for the next iteration of method 300. Another sample image is then acquired at 304, and the method 300 is repeated from 304.

It will be understood by a person of ordinary skill in the art that functions performed by optical motion sensor 106 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

One form of the present invention provides an optical screen pointing device with more power savings than prior art optical pointing devices. In one embodiment, the light source 118 of optical pointing device 10 is controlled based on surface quality values calculated for the imaging surface on which the pointing device 10 is being operated. The power savings achieved by embodiments of the present invention provide for longer battery life in battery-operated pointing devices, and/or the ability to use smaller batteries.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for controlling a light source of an optical pointing device, the method comprising:
generating quality data representative of a surface quality of an imaging surface being imaged by the optical pointing device; and
controlling the light source based on the generated quality data.

2. The method of claim 1, wherein the quality data represents a number of features appearing in images of the imaging surface.

3. The method of claim 1, wherein the step of controlling the light source comprises:
adjusting an amplitude of the light source based on the quality data.

4. The method of claim 1, wherein the step of controlling the light source comprises:
adjusting a duty cycle of the light source based on the quality data.

5. The method of claim 1, wherein the step of controlling the light source comprises:
reducing an amplitude of the light source when the quality data exceeds a threshold value.

6. The method of claim 1, wherein the step of controlling the light source comprises:
reducing a duty cycle of the light source when the quality data exceeds a threshold value.

7. The method of claim 1, wherein the optical pointing device is configured to output zero values for movement information if the quality data falls below a threshold level.

8. The method of claim 1, wherein the light source comprises an LED.

9. An apparatus for controlling the position of a screen pointer for an electronic device having a display screen, the apparatus comprising:
a light source for illuminating an imaging surface, thereby generating reflected images; and
an optical motion sensor configured to generate digital images from the reflected images, generate quality data and movement data based on the digital images, the movement data indicative of relative motion between the imaging surface and the apparatus, the quality data indicative of a surface quality of the imaging surface, and wherein the motion sensor is configured to control the light source based on the quality data.

10. The apparatus of claim 9, wherein the quality data represents a number of features appearing in the digital images.

11. The apparatus of claim 9, wherein the optical motion sensor is configured to adjust a drive current to the light source based on the quality data.

12. The apparatus of claim 9, wherein the optical motion sensor is configured to adjust an on-time of the light source based on the quality data.

13. The apparatus of claim 9, wherein the optical motion sensor is configured to reduce an on-time of the light source when the quality data exceeds a threshold value.

14. The apparatus of claim 9, wherein the optical motion sensor is configured to reduce an amplitude of the light source when the quality data exceeds a threshold value.

15. The apparatus of claim 9, wherein the optical motion sensor is configured to turn the light source on if the quality data rises above a threshold value.

16. The apparatus of claim 9, wherein the apparatus is configured to output zero values for the movement data if the quality data falls below a threshold value.

17. The apparatus of claim 9, wherein the apparatus is an optical mouse, and wherein the light source includes at least one LED.

18. A method of generating movement data with an optical pointing device, the method comprising:
illuminating an imaging surface with a light source, thereby generating reflected images;
generating surface quality data indicative of a quality of the imaging surface;
controlling the light source based on the quality data; and
generating movement data based on the reflected images.

19. The method of claim 18, wherein the surface quality data represents a number of features of the imaging surface.

20. The method of claim 18, wherein the step of controlling the light source comprises:
adjusting at least one of a duty cycle and an amplitude of the light source based on the quality data.
